(19) United States
(12) Patent Application Publication
(10) Pub. No.: US 2006/0053485 A1
(43) Pub. Date: Mar. 9, 2006

(54) Network connection through NAT routers and firewall devices

(76) Inventor: Chia-Hsin Li, San Jose, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/935,980

(22) Filed: Sep. 8, 2004

(51) Int. Cl. G06F 15/16

(52) U.S. Cl. 726/11

(57) ABSTRACT

A method for communication and data exchange between two or more systems located in separate, private networks with each network behind a firewall device includes establishing communication with a proxy server. A first system and a second system establish a TCP connection with the proxy server. A TCP probing packet is transmitted to expose the port and address mapping of each firewall device for the systems in the network, and the mapping is provided to the systems. The proxy server commands each system to transmit a SYN packet to the other system, and then to transmit a SYN+ACK packet. The proxy server is used to facilitate the systems establishing essentially direct communication, and enables continued TCP data packet exchange without continued involvement of the proxy server.

### BACKGROUND OF THE INVENTION

1. Field of the Invention

The present invention relates generally to network communications, and more specifically to data exchange within an environment of network address translators (NATs) and firewall devices.

2. Description of the Related Art

The continued expansion and use of the Internet inevitably leads to corresponding burdens on Internet infrastructure, such as bandwidth and IP address sharing. The burden of IP address sharing has one root cause in the very limited number of addresses that the Internet (IPv4) can accommodate. IPv4 is currently the most popular IP address standard in today's industry. However, the maximum number of addresses supported by IPv4 is limited at just over four billion addresses. The limit on available IP addresses correspondingly limits the number of users that can connect to the Internet at the same time. As the number of users increases, 4 billion addresses are rapidly becoming insufficient.

One method of overcoming the limitation of available IP addresses is to share one IP address among many computers. Several computers can be interconnected by a local area network (LAN), but have only one IP address to connect to the Internet. A NAT can provide for each of the several computers to connect to the Internet by manipulating and translating Internet communication to maintain a single (or few) source and destination address for all of the IP packets sent and received for the several computers. As is known, there are routers designed to achieve NAT, called NAT routers, and as used herein the term “NAT” includes both NAT and NAT routers. Examples of NAT routers includes Linksys Etherfast cable/DSL firewall router, Netgear cable/DSL router, and others.

One limitation of NAT is that, while several computers can use a single IP address to communicate over the Internet, two or more computers on different LANs, behind different NATs are prevented from direct communication.

FIG. 1 is a system diagram 10 illustrating typical Internet communication implementing NATs. Each of computers 12a, 12b, and 12c, is capable of connecting to the Internet 22 through NAT-1 14. Similarly, each of computers 16a, 16b, and 16c, is capable of connecting to the Internet 22 through NAT-2 18. Computer 12a, for example, is typically not capable of making a direct connection to computer 16a, as the only IP address that either computer 12a or 16a is capable of seeing is the IP address of the respective NAT 14, 18.

One method of establishing and maintaining a connection for the exchange of TCP packets between, for example, computer 12a behind NAT-1 14 and computer 16a behind NAT-2 18 is through use of centralized server 20. Packets from computer 12a are routed by NAT-1 14 to centralized server 20, which then routes the traffic to NAT-2 18 which in turn routes the traffic to computer 16a. Similarly, traffic from computer 16a is routed through NAT-2 18 to centralized server 20 which transmits the traffic to NAT-1 14 for routing to computer 12a.

One obvious drawback to the described solution is, while communication is effectively established between computers 12a and 16a, communication traffic is essentially doubled by transmission to and from proxy server 20. Embodiments of the present invention establish a more direct communication path between two computers located on different LANs which are separated by two NAT routers. With the advent and now common implementation of firewall protection, embodiments of the present invention further provide for the more direct communication path in a firewall environment. Advantageously, embodiments of the present invention will work on most of the NAT routers found in today's market without modification to the NAT routers.

### SUMMARY OF THE INVENTION

Broadly speaking, the present invention fills these needs by providing methods for communication exchange between two computers located behind NAT routers and firewall devices. The present invention can be implemented in numerous ways, including as a process, an apparatus, a system, a device, a method, integrated computer logic, or a computer readable media. Several embodiments of the present invention are described below.

In one embodiment, a system for exchanging communication is provided. The system includes a first computing entity located in a first private network, and a second computing entity located in a second private network. The system further includes a first firewall device protecting the first private network. The first firewall device is configured to perform network address translation. Also provided is a second firewall device protecting the second private network. The second firewall device is configured to perform network address translation. The system also includes a proxy server. The proxy server is a part of neither the first private network nor the second private network. The first computing entity and the second computing entity are enabled to essentially directly exchange communication packets. The first computing entity is configured to transmit communication packets through the first firewall device to the second computing entity behind the second firewall device and to receive communication packets from the second computing entity transmitted through the second firewall device and the first firewall device. The second computing entity is configured to transmit communication packets through the second firewall device to the first computing entity behind the first firewall device and to receive communication packets from the first computing entity transmitted through the first firewall device and the second firewall device.

In another embodiment, a method for communication between two or more computers on at least two private networks is provided. A first computer is behind a first firewall device, and a second computer is behind a second firewall device. The method includes establishing communication with a proxy server. The first computer and the second computer establish a TCP connection with the proxy server. The method further includes transmitting a TCP SYN probing packet. The first computer and the second computer each transmit a TCP SYN probing packet to the proxy server. The method also provides for transitioning the first computer and the second computer to a connection established state according to TCP protocol. Finally, the method provides for exchanging TCP data packets between the first computer behind the first firewall device and the second computer behind the second firewall device. The exchanging is essentially direct communication between the first computer behind the first firewall device and the second computer behind the second firewall device.

In a further embodiment, a method of conducting a communication exchange between systems located in separate private networks is provided. Each separate private network has a firewall device. The method includes establishing a TCP connection between a proxy server and a first system behind a first firewall device, and establishing a TCP connection between a proxy server and a second system behind a second firewall device. Next, the method provides for transmitting a SYN packet from the first system to the second system, and transmitting a SYN packet from the second system to the first system. Then, the method provides for transmitting a SYN+ACK packet from the first system to the second system, and transmitting a SYN+ACK packet from the second system to the first system. Finally, the method provides for exchanging TCP packets between the first system behind the first firewall device and the second system behind the second firewall device.

In yet another embodiment, a method for establishing a communication link between two or more computers located in separate private network is provided. Each separate private network has a firewall device. The method includes establishing a TCP connection between a first computer and a proxy server, and establishing a TCP connection between a second computer and a proxy server. Then, the method provides for directing the first computer to transmit a SYN packet to the second computer, and directing the second computer to transmit a SYN packet to the first computer. The method further includes directing the first computer to transmit a SYN+ACK packet to the second computer, and directing the second computer to transmit a SYN+ACK packet to the first computer. The method includes receiving the SYN+ACK packet at the second computer, and transitioning to a TCP Connection Established state by the second computer. Further, the method includes receiving the SYN+ACK packet at the first computer, and transitioning to the TCP Connection Established state by the first computer.

In still a further embodiment, an integrated circuit chip for establishing data exchange between systems located in separate private networks is provided. Each separate private network has a firewall device. The integrated circuit chip includes logic for establishing a TCP connection between a first computer and a proxy server, and logic for establishing a TCP connection between a second computer and a proxy server. Additionally, the integrated circuit chip includes logic for directing the first computer to transmit a SYN packet to the second computer, and logic for directing the second computer to transmit a SYN packet to the first computer. Further, the integrated circuit chip includes logic for directing the first computer to transmit a SYN+ACK packet to the second computer, and logic for directing the second computer to transmit a SYN+ACK packet to the first computer. When the second computer receives the SYN+ACK packet transmitted by the first computer, the second computer transitions to a TCP Connection Established state. When the first computer receives the SYN+ACK packet transmitted by the second computer, the first computer transitions to the TCP Connection Established state.

In another embodiment, a computer readable media having program instructions for establishing a communication link between two or more computers located in separate private networks is provided. Each separate private network has a firewall device. The computer readable media includes program instructions for establishing a TCP connection between a first computer and a proxy server, and program instructions for establishing a TCP connection between a second computer and a proxy server. Further, the computer readable media includes program instructions for directing the first computer to transmit a SYN packet to the second computer, and program instructions for directing the second computer to transmit a SYN packet to the first computer. Additionally, the computer readable media includes program instructions for directing the first computer to transmit a SYN+ACK packet to the second computer, and program instructions for directing the second computer to transmit a SYN+ACK packet to the first computer. When the second computer receives the SYN+ACK packet transmitted by the first computer, the second computer transitions to a TCP Connection Established state. When the first computer receives the SYN+ACK packet transmitted by the second computer, the first computer transitions to the TCP Connection Established state.

The advantages of the present invention over the prior art are numerous and will become apparent from the following detailed description, taken in conjunction with the accompanying drawings, illustrating by way of example the principles of the invention.

### BRIEF DESCRIPTION OF THE DRAWINGS

The accompanying drawings, which are incorporated in and constitute part of this specification, illustrate exemplary embodiments of the invention and together with the description serve to explain the principles of the invention.

FIG. 1 is a system diagram illustrating typical Internet communication implementing NATs.

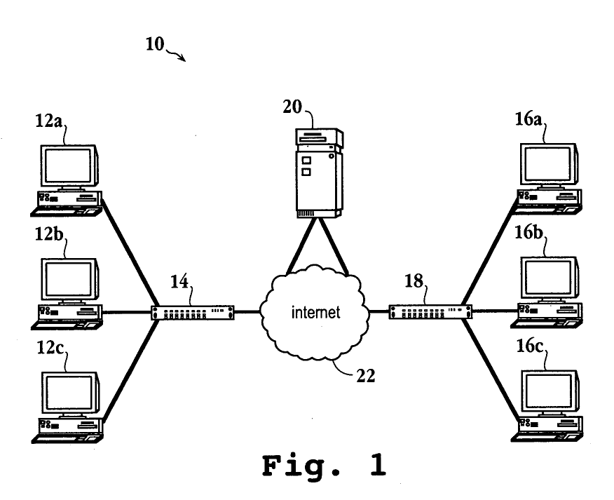

FIG. 2 is a system diagram illustrating a method of establishing a UDP packet exchange between two computers located behind respective NATs, in accordance with one embodiment of the present invention.

FIG. 3 is a system diagram illustrating network and Internet communication in a firewall environment.

FIG. 4 is a state diagram illustrating typical client and server state progression when establishing TCP connection in the absence of any barriers or limitations such as firewall protection.

FIG. 5 is a simplified system diagram illustrating network and Internet communication in a firewall environment as shown in FIG. 3, for client computer 1 behind firewall-1, and client computer 2 behind firewall-2, in accordance with one embodiment of the present invention.

FIG. 6 is a state diagram illustrating the state transitions for each of firewall-1 and firewall-2 shown in FIG. 5, in accordance with an embodiment of the invention.

FIG. 7 is a flow chart diagram illustrating the method operations performed in establishing a TCP connection between two computers on different LANs behind two different firewalls in accordance with one embodiment of the present invention.

### DETAILED DESCRIPTION OF THE PREFERRED EMBODIMENTS

An invention for a method and system for communication and information exchange is described. In preferred embodiments, essentially direct data exchange between systems located in separate, private networks behind firewalls is enabled. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

In one embodiment of the present invention, NAT routers perform only source network address translation (SNAT) in which the port mapping is determined by the source IP and source port (also known as Full-Cone type NAT). Additionally, no firewall features, such as port blocking, UDP packet blocking, connection tracking, etc., are implemented. In order to enable the exchange of UDP packets between two computers separated by two NAT routers, a proxy server is used to discover the NAT port mapping, and to exchange the port mapping information between two computers being connected.

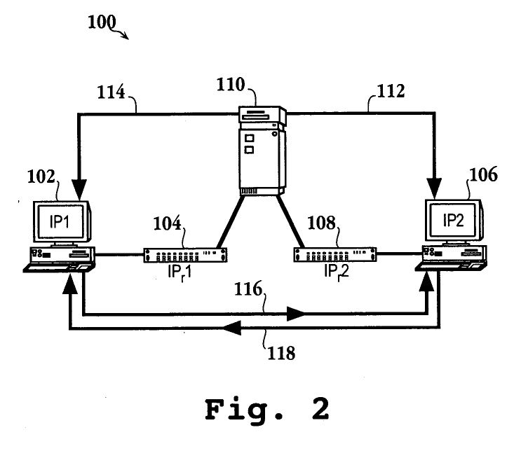

FIG. 2 is a system diagram 100 illustrating a method of establishing a UDP packet exchange between two computers 102, 106, located behind respective NATs 104, 108, in accordance with one embodiment of the present invention. Computer-1 102 has an IP address of IP1. A probing packet sent from IP 1 has a UDP source port number of P1. NAT-1 104 has an IP address of IPr1. Pr1 is the UDP source port number of IPr1 used to forward the probing packet. Computer-2 106 has an IP address of IP2. A probing packing sent from IP2 has a UDP source port number of P2. NAT-2 108 has an IP address of IPr2. Pr2 is the UDP source port number of IPr2 used to forward the probing packet. As used herein, address and port are indicated by the notation X:Y where X signifies the IP address and Y signifies the port. For example, IP1:P1 identifies the UDP source address and port as IP address IP1 and port P1.

In one embodiment of the invention, computer-1 102 and computer-2 106 make a TCP connection to proxy server 110 to expose and exchange respective port mapping information. Computer-1 102 sends a probing UDP packet to the proxy server 110 using port P1. When NAT-1 104 receives the probing packet, a mapping table is created that maps IP1:P1 to IPr1:Pr1. Similarly, computer-2 106 sends a probing UDP packet to the proxy server 110 using port P2. When NAT-2 108 receives the probing packet, a mapping table is created that maps IP2:P2 to IPr2:Pr2.

When proxy server 110 receives the probing UDP packets, the mapping information is exposed to the proxy server in the UDP packet headers. For example, IP1:P1 is sent to proxy server 110 by TCP connection. When the probing packet arrives at proxy server 110, the source IP and port of the packet header is IPr1:Pr1, with the IP1:P1 address and port in the UDP packet header. The address translation is performed by the NAT router between computer-1 102 and proxy server 110. In this manner, the IP1:P1 IPr1:Pr1 mapping of NAT-1 104 is exposed to the proxy server. Similarly, IP2:P2 is sent to proxy server 110 by TCP connection. When the probing packet arrives at proxy server 110, the source IP and port of the packet header is IPr2:Pr2, with the IP2:P2 address and port in the UDP packet header. In this manner, the IP2:P2⇄IPr2:Pr2 mapping of NAT-2 108 is exposed to the proxy server.

In one embodiment of the present invention, the exposed mapping is then sent to the computers 102, 106, so that each computer 102, 106, has the port mapping of the other, enabling the essentially direct exchange between computer-1 102 and computer-2 106 of UDP packets. Once the mapping has been exposed, computer-1 102 using IP1:P1 can send UDP packets directly to computer-2 106 at IP2:P2, and vice versa. As shown in FIG. 2, communication line 112 reflects proxy server 110 forwarding exposed mapping of IP1:P1⇄IPr1:Pr1 to computer-2 106 and indicating IPr1:Pr1 is accepting UDP packets that will be forwarded to IP1:P1. Similarly, communication line 114 reflects proxy server 110 forwarding exposed mapping of IP1:P2⇄IPr2:Pr2 to computer-1 102 and indicating IPr2:Pr2 is accepting UDP packets that will be forwarded to IP2:Pr2.

In one embodiment, two computers such as computer-1 102 behind NAT-1 104 and computer-2 106 behind NAT-2 108 are able to connect to each other with almost no bandwidth and computing overhead. Once the NAT mapping information is discovered, the proxy server 110 is no longer required for communication exchange, significantly reducing bandwidth and computing load of the proxy server 110.

In the previous embodiment, it is assumed that the NATs 104, 108, allow UDP packets to pass through. Some NAT and firewall devices, however, block all UDP packets. In another embodiment of the present invention, essentially direct communication channels are established in an environment having a firewall or similar function performed by a NAT that blocks all UDP packets.

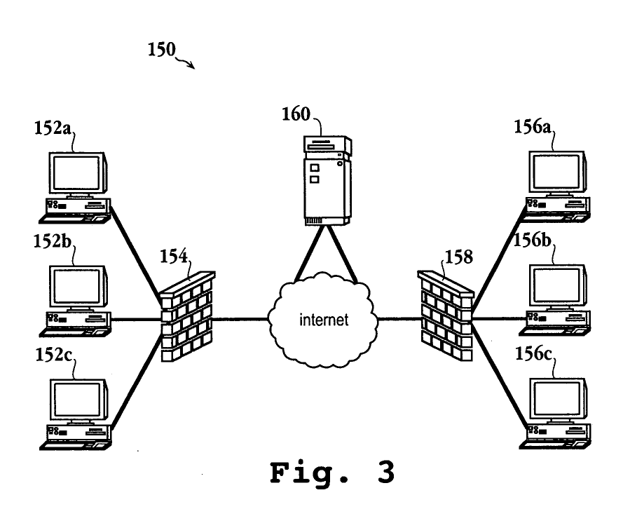

In one embodiment of the present invention, essentially direct communication is established and maintained between two computers located on different private LANs which are separated by two firewall devices, or similarly functioning NAT routers, hereinafter referred to collectively as firewall devices. FIG. 3 is a system diagram 150 illustrating network and Internet communication in a firewall environment. Client computers 152a, 152b, and 152c represent a private LAN behind firewall-1 154. Client computers 156a, 156b, and 156c represent another private LAN behind firewall-2 158. Proxy server 160 is used to initially establish the connection. In the present embodiment, firewall devices 154, 156 allow TCP connections, port numbers are not restricted, and Full-cone NAT is implemented according to RFC3489.

In one embodiment, a command channel (i.e., TCP connection) is opened to enable proxy server 160 to communicate with each client computer for establishing a direct communication between the client computers. For example, a command channel is established for proxy server 160 to communicate with client-1 152a behind firewall-1 154, and to communicate with client-2 156a behind firewall-2 158. Once the command TCP connections are established, proxy server 160 can command each of client computers 152a, 156a. In one embodiment, proxy server 160 commands each of client computers 152a, 156a to send probing TCP packets, e.g., TCP SYN packets.

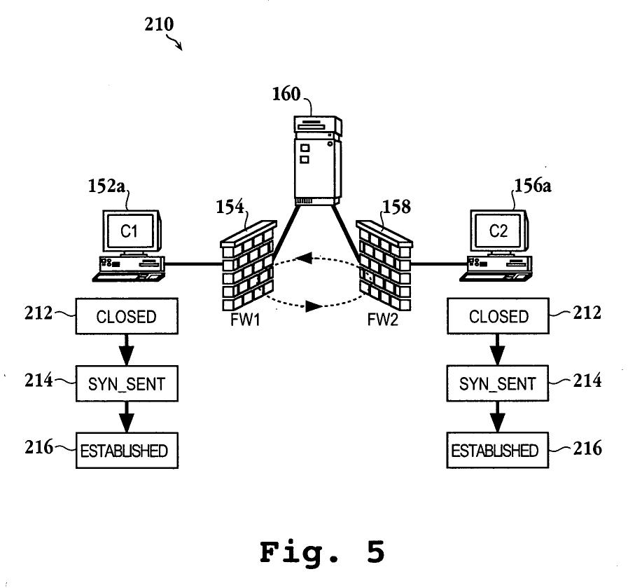

When client computers 152a, 156a send probing TCP SYN packets, and the probing packets are received by proxy server 160, mapping is exposed as was described above in reference to FIG. 2. A firewall mapping table is created that maps a computer IP and Port to the corresponding firewall IP and Port when the probing TCP packets are sent. The mapping is exposed to proxy server 160 when the probing packets are received by proxy server 160, and then proxy server 160 sends the mapping information to the cooperating computer. In FIG. 3, for example, if computers 152a and 156a were intended to establish communication, proxy server 160 would send the exposed mapping information about computer 152a to computer 156a, and would send the exposed mapping information about computer 156a to computer 152a. This example is illustrated in more detail below in FIG. 5.

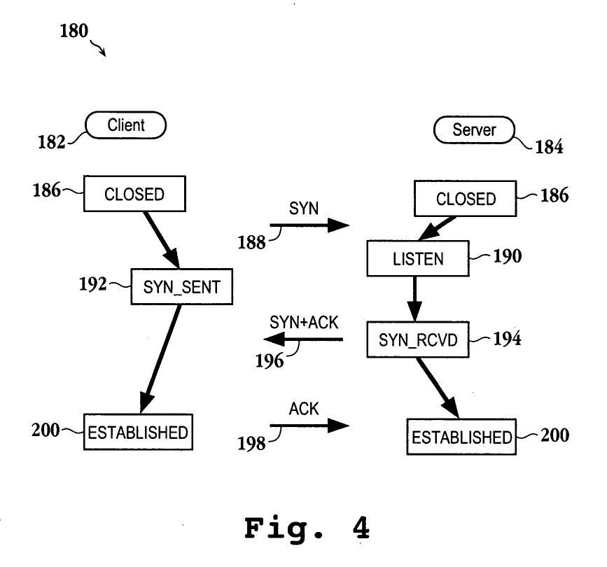

FIG. 4 is a partial state diagram 180 illustrating typical TCP connection client 182 and server 184 state progression when establishing a TCP connection. As is known, such state progression is defined by TCP protocol, and the simplified process depicted in FIG. 4 is used to illustrate what must occur for a TCP connection to be established. Later figures illustrate embodiments of the present invention and how required processes are achieved for TCP state progression in a firewall environment. As illustrated in FIG. 4, both client 182 and server 184 are initially in a closed 186 state. When the server program calls the TCP “listen( )” system call, server 184 transitions to listen state 190. When client 182 desires to establish TCP connection with server 184, client 182 transmits a SYN packet 188 to server 184. Upon transmission of SYN packet 188, client transitions to SYN_SENT state 192. When server 184 receives the SYN packet 188, server 184 transitions from listen 190 to SYN_RCVD 194. Server 184 then transmits a SYN+ACK packet 196. Client 182 receives the SYN+ACK packet 196, transitions to established 200, the data transfer state required for TCP packet exchange, and transmits an ACK packet 198 to server 184. Upon receipt of the ACK packet 198, server 184 transitions to the established state 200. With both client 182 and server 184 in the established state 200, a TCP connection is open and data transfer and exchange is enabled.

Turning back to FIG. 3, embodiments of the present invention provide for TCP connection between two client computers 152a, 156a, behind firewalls 154, 158, respectively. As is known, firewall devices typically block UDP packets, perform port blocking, etc. Firewall devices also block incoming SYN packets to prevent external machines (e.g., hackers) from making connections to machines in the private network. In embodiments of the present invention, the incoming SYN packet sent to the firewall will be ignored and will have no negative effect on the establishing of the connection. In FIG. 3, proxy server 160 is used to orchestrate the establishing of a TCP connection between the two client computers 152a, 156a, through firewalls 154, 158.

FIG. 5 is a simplified system diagram 210 illustrating network and Internet communication in a firewall environment as shown in FIG. 3, for client computer 1 (client-1) 152a behind firewall-1 154, and client computer 2 (client-2) 156a behind firewall-2 158, in accordance with one embodiment of the present invention. Proxy server 160, having already initiated the sending of probing TCP packets to expose the IP and port mapping, and then exchanged the IP and port mapping between the computers 152a, 156a, sends a sequence of TCP connection establishing packets to each of client-1 152a and client-2 156a to facilitate creating a TCP tunnel through both firewalls 154, 158. Client-1 152a sends packets from source IP and port C1:P1 through firewall-1 154 having IP and port FW1:FP1. Client-2 156a sends packets from source IP and port C2:P2 through firewall-2 158 having IP and port FW2:FP2.

In one embodiment of the present invention, TCP connections between client-1 152a and proxy server 160, and between client-2 156a and proxy server 160 are used to orchestrate the establishing of an essentially direct TCP connection between client-1 152a and client-2 156a. As described above in reference to FIG. 4, TCP protocol requires a sequence of client or server states to achieve connection status. In FIG. 5, client states are identified below each of client-1 152a and client-2 156a. Both client-1 152a and client-2 156a are assumed to start in a closed state 212 with respect to the corresponding client intended for TCP connection.

In accordance with one embodiment of the invention, proxy server 160 commands client-1 152a to send a SYN packet to client-2 156a. Firewall-2 158 will block the SYN packet, protecting client-2 156a located behind firewall-2 158. A SYN packet transmitted from client-1 152a will not be blocked by firewall-1 154. In other words, firewall-1 154 does not block the SYN packet originating from client-1 152a behind firewall-1 154, but rather will block any SYN packet external to fireall-1 154 transmitted to client-1 152a. Upon transmission of the SYN packet, client-1 152a transitions to a SYN_SENT state 214.

Similarly, proxy server 160 commands client-2 156a to send a SYN packet to client-1 152a. Firewall-1 154 will block and ignore the SYN packet, protecting client-1 152a located behind firewall-1 154, as described above in reference to client-2 156a. However, upon transmission of the SYN packet, client-2 156a transitions to a SYN_SENT state 214.

As is known, firewall devices generally block UDP packets, etc., to protect clients and systems located behind the firewall. When the protected client desires to connect to another entity, for example to conduct TCP packet exchange with a server, transmission is permitted from the client to the destination entity as long as the proper TCP state transition is made. Further, such transmissions are typically paired with acknowledgement packets. By way of example, a SYN packet is typically expected to generate a return SYN+ACK acknowledgement packet. Because the SYN packet originated behind the firewall, and a SYN+ACK packet is expected in reply, the firewall will allow the replying SYN+ACK, packet to pass through the firewall to the client if the SYN packet had been sent from client.

Looking again at FIG. 5, with both client-1 152a and client-2 156a in the SYN_SENT state 214, proxy server 160 commands client-1 152a to send a SYN+ACK packet to client-2, and further commands client-2 156a to send a SYN+ACK packet to client-1 152a. With each client 152a, 156a, in a SYN_SENT state 214, each SYN+ACK packet will pass through the respective firewall 154, 158. When client-1 152a receives the SYN+ACK packet from client-2 156a, client-1 152a transitions to the established state 200. When client-2 receives the SYN+ACK packet from client-1, client-2 156a transitions to the established state 200. Essentially direct TCP packet exchange is now enabled between client-1 152a and client-2 156a.

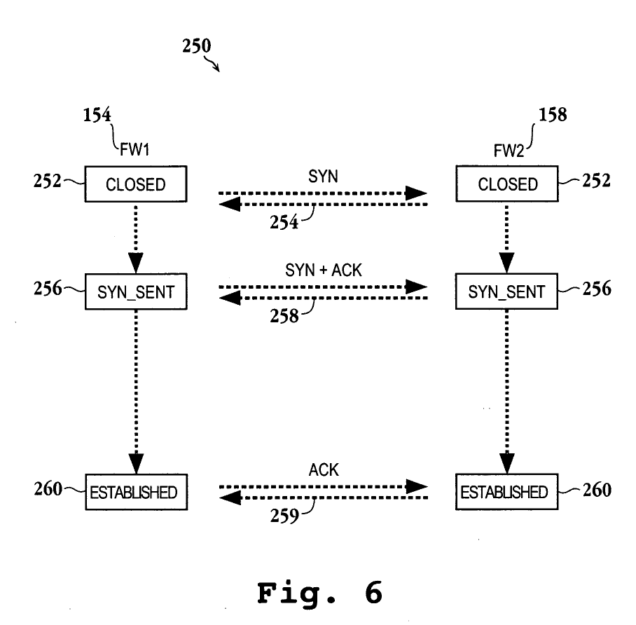

FIG. 6 is a state diagram 250 illustrating the client-1/client-2 TCP connection state transitions for each of firewall-1 154 and firewall-2 158 shown in FIG. 5, in accordance with an embodiment of the invention. Both firewalls 154, 158 start in a closed state 252 for the connection. It should be understood that reference to a firewall state generally signifies the TCP connection state of client-1 and client-2. As is known, a firewall may monitor connections/connection states of multiple machines. When client-1 152a (see FIG. 5) transmits a SYN packet 254, the packet originates behind firewall-1 154, and therefore is permitted to pass. The state of firewall-1 154 transitions to SYN_SENT 256 when the SYN packet is permitted to pass. Although the SYN packet sent by client-1 152a is blocked at firewall-2 158, the transmission of the SYN packet 254 transitions firewall-1 154 into the SYN_SENT state 256. Similarly, when client-2 156a (see FIG. 5) transmits a SYN packet 254, the packet originates behind firewall-2 158, and therefore is permitted to pass. The state of firewall-2 158 transitions to SYN_SENT 256 when the SYN packet is permitted to pass. Although the SYN packet sent by client-2 156a is blocked at firewall-1 154, the transmission of the SYN packet 254 transitions firewall-2 158 into the SYN_SENT state 256.

With both firewall-1 154 and firewall-2 158 in a SYN_SENT state 256, client-1 152a (see FIG. 5) transmits a SYN+ACK packet 258 to client-2 156a (see FIG. 5), and client-2 156a transmits a SYN+ACK packet 258 to client-1 152a. When firewall-2 158 receives the SYN+ACK packet 258 transmitted by client-1 152a, firewall-2 158 permits the packet to pass to client-2 156a, and firewall-2 158 transitions to the established state 260. When firewall-1 254 receives the SYN+ACK packet 258 transmitted by client-2 156a, firewall-1 154 permits the packet to pass to client-1 152a, and firewall-1 154 transitions to the established state 260. Finally, client-1 152a transmits an ACK packet 259 to client-2 156a, and client-2 156a transmits an ACK packet 259 to client-1 152a to complete the connection establishment. In the established state 260, both firewall-1 154 and firewall-2 158 are ready and configured to receive and to forward TCP data packets.

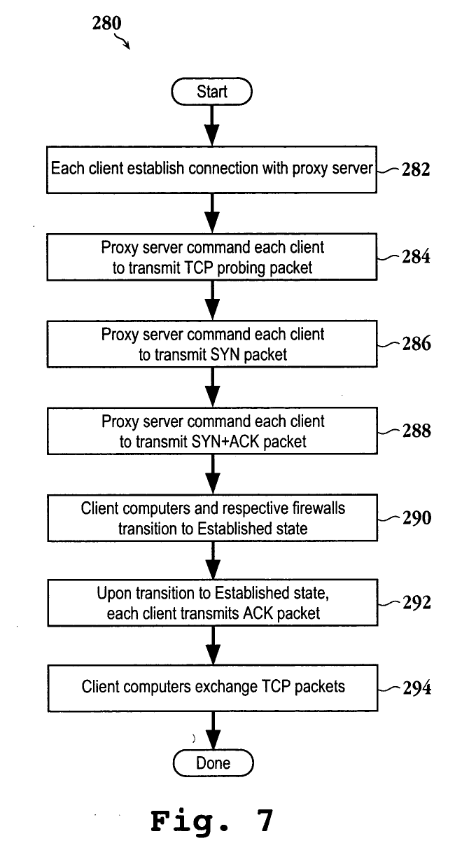

FIG. 7 is a flow chart diagram 280 illustrating the method operations performed in establishing a TCP connection between two computers on different LANs behind two different firewalls in accordance with one embodiment of the present invention. The method begins with operation 282 in which each client establishes connection with the proxy server. As described above in reference to FIGS. 5 and 6, a proxy server is used to command the two client computers to send TCP connection establishing packets, thereby facilitating the establishing of the essentially direct connection between the two client computers, in one embodiment of the invention.

The method continues with operation 284 in which the proxy server commands each client to transmit an IP probing packet. In one embodiment, the IP probing packet is a TCP probing packet. As described above, address mapping is generally discovered to the proxy server in the header of the IP probing packet. The proxy server then exposes the IP and port mapping to each of the corresponding participating clients.

In operation 286, the proxy server commands each client to transmit a SYN packet to the other client. In one embodiment, each client is behind a firewall device. A client transmitting a SYN packet from behind a firewall device will successfully transmit through the firewall with the outbound packet, but each inbound SYN packet, with the intended client recipient behind a firewall will be stopped or dropped by the firewall. Upon transmitting the SYN packet, however, each client transitions to a SYN_SENT state. The firewall, in one embodiment, realizes client state transitions, and will subsequently allow a reply ACK (or SYN+ACK) to pass through the firewall to the client.

The method continues with operation 288 in which the proxy server commands each client to transmit a SYN+ACK packet. As described above, following transmission of a SYN packet in operation 286, each client transitions to the SYN_SENT state. In the SYN_SENT state, each SYN+ACK packet will be permitted to pass through the respective firewall to the intended recipient client.

Operation 290 illustrates that, upon receipt of the SYN+ACK packet, each client computer transitions to the Established state, and in operation 292, each client computer transmits an ACK packet to finish the TCP connection establishment. At this point, the connection is established and TCP data packet exchange is enabled between the clients. In one embodiment of the invention, each client behind a separate firewall device is capable of TCP data packet exchange with the other client with which the TCP connection has been enabled. It is neither necessary nor desirable to route TCP packets through the proxy server, but rather essentially directly exchange the TCP data packets between the clients.

The method concludes with operation 294 signifying continuing exchange of TCP data packets between participating clients. At such a time as data exchange is complete, no longer desired, or the connection is interrupted or severed, the method is done. It should be appreciated that, in accordance with TCP protocol, TCP FIN packets are sent from each computer on connection tear-down to sever or tear down the TCP connections.

It should be appreciated that embodiments of the present invention are particularly advantageous when implemented for multiparticipant videoconferencing systems, file transfer, application sharing programs, multi-media streaming of data, and other high-data-volume data transmission and exchange operations.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for exchanging communication, comprising:
a first computing entity located in a first private network;
a second computing entity located in a second private network;
a first firewall device protecting the first private network, the first firewall device being configured to perform network address translation;
a second firewall device protecting the second private network, the second firewall device being configured to perform network address translation; and
a proxy server, the proxy server being a part of neither the first private network nor the second private network;
wherein the first computing entity and the second computing entity are enabled to essentially directly exchange communication packets, the first computing entity being configured to transmit communication packets through the first firewall device to the second computing entity behind the second firewall device and to receive communication packets from the second computing entity transmitted through the second firewall device and the first firewall device, the second computing entity being configured to transmit communication packets through the second firewall device to the first computing entity behind the first firewall device and to receive communication packets from the first computing entity transmitted through the first firewall device and the second firewall device.

2. The system of claim 1, wherein the proxy server is configured to expose the IP and port address mapping of the first computing entity and first firewall device to the second computing entity, and the proxy server is further configured to expose the IP and port address mapping of the second computing entity and second firewall device to the first computing entity.

3. The system of claim 2, wherein the proxy server is further configured to enable each of the first computing entity and the second computing entity to establish an essentially direct communication exchange, the essentially direct communication exchange being without a routing of communication packets of the essentially direct communication exchange through the proxy server.

4. The system of claim 3, wherein the enabling of each of the first computing entity and the second computing entity to establish an essentially direct communication exchange includes,
establishing a TCP connection between the first computing entity and the proxy server;
establishing a TCP connection between the second computing entity and the proxy server;
directing the first computing entity to transmit a SYN packet to the second computing entity;
directing the second computing entity to transmit a SYN packet to the first computing entity;
directing the first computing entity to transmit a SYN+ACK packet to the second computing entity;
directing the second computing entity to transmit a SYN+ACK packet to the first computing entity;
receiving the SYN+ACK packet at the second computing entity;
transitioning to a TCP Connection Established state by the second computing entity;
directing the first computing entity to transmit an ACK packet to finish the connection establishment;
receiving the SYN+ACK packet at the first computing entity;
transitioning to the TCP Connection Established state by the first computing entity; and
directing the second computing entity to transmit an ACK packet to finish establishing the essentially direct communication between the first computing entity and the second computing entity.

5. A method for communication between two or more computers on at least two private networks, a first computer behind a first firewall device and a second computer behind a second firewall device, the method comprising:
establishing communication with a proxy server, the first computer and the second computer establishing a TCP connection with the proxy server;
transmitting an TCP SYN probing packet, the first computer and the second computer each transmitting a TCP SYN probing packet to the proxy server;
transitioning the first computer and the second computer to a connection established state according to TCP protocol; and
exchanging TCP data packets between the first computer behind the first firewall device and the second computer behind the second firewall device, the exchanging being essentially direct communication between the first computer behind the first firewall device and the second computer behind the second firewall device.

6. The method according to claim 5, wherein the transitioning the first computer and the second computer to a connection established state according to TCP protocol comprises:
transmitting a SYN packet, the proxy server commanding the first computer behind the first firewall device to transmit a SYN packet to the second computer and the proxy server commanding the second computer behind the second firewall device to transmit a SYN packet to the first computer; and
transmitting a SYN+ACK packet, the proxy server commanding the first computer behind the first firewall device to transmit a SYN+ACK packet to the second computer and the proxy server commanding the second computer behind the second firewall device to transmit a SYN+ACK packet to the first computer.

7. The method according to claim 5, wherein the transmitting of the TCP SYN probing packets exposes port and IP mapping to the proxy server.

8. The method of claim 7, further comprising:
exposing the port and IP mapping of the first computer behind the first firewall device to the second computer; and
exposing the port and IP mapping of the second computer behind the second firewall device to the first computer.

9. The method of claim 5, wherein the establishing of communication with the proxy server defines a command channel between the proxy server and the first computer and between the proxy server and the second computer.

10. A method of conducting a communication exchange between systems located in separate private networks, each separate private network having a firewall device, the method comprising:
establishing a TCP connection between a proxy server and a first system behind a first firewall device;
establishing a TCP connection between a proxy server and a second system behind a second firewall device;
transmitting a SYN packet from the first system to the second system;
transmitting a SYN packet from the second system to the first system;
transmitting a SYN+ACK packet from the first system to the second system;
transmitting a SYN+ACK packet from the second system to the first system; and
exchanging TCP packets between the first system behind the first firewall device and the second system behind the second firewall device.

11. The method of claim 10, wherein the transmitting of the SYN packet from the first system to the second system includes the proxy server commanding the first system behind the first firewall device to transmit the SYN packet to the second system, the SYN packet being blocked by the second firewall device and yet the firewall state transitions to SYN_SENT state

12. The method of claim 10, wherein the transmitting of the SYN packet from the second system to the first system includes the proxy server commanding the second system behind the second firewall device to transmit the SYN packet to the first system, the SYN packet being blocked by the first firewall device and yet the firewall state transitions to SYN_SENT state.

13. The method of claim 10, wherein the transmitting of the SYN+ACK packet from the first system to the second system includes the proxy server commanding the first system behind the first firewall device to transmit the SYN+ACK packet to the second system, the SYN+ACK packet being allowed to pass through the second firewall device and the firewall state transitions to ESTABLISHED state.

14. The method of claim 10, wherein the transmitting of the SYN+ACK packet from the second system to the first system includes the proxy server commanding the second system behind the second firewall device to transmit the SYN+ACK packet to the first system, the SYN+ACK packet being allowed to pass through the first firewall device and the firewall state transitions to ESTABLISHED state.

15. The method of claim 10, wherein when the second system receives the SYN+ACK packet transmitted from the first system to the second system, the second system transitions to a TCP Connection Established state.

16. The method of claim 10, wherein when the first system receives the SYN+ACK packet transmitted from the second system to the first system, the first system transitions to a TCP Connection Established state.

17. A method for establishing a communication link between two or more computers located in separate private networks, each separate private network having a firewall device, the method comprising:
establishing a TCP connection between a first computer and a proxy server;
establishing a TCP connection between a second computer and a proxy server;
directing the first computer to transmit a SYN packet to the second computer;
directing the second computer to transmit a SYN packet to the first computer;
directing the first computer to transmit a SYN+ACK packet to the second computer;
directing the second computer to transmit a SYN+ACK packet to the first computer;
receiving the SYN+ACK packet at the second computer;
transitioning to a TCP Connection Established state by the second computer;
directing the first computer to transmit a ACK packet to finish the connection establishment;
receiving the SYN+ACK packet at the first computer;
transitioning to the TCP Connection Established state by the first computer; and
directing the second computer to transmit a ACK packet to finish the connection establishment.

18. The method of claim 17, wherein the directing of the first computer to transmit a SYN packet to the second computer and the directing of the first computer to transmit a SYN+ACK packet to the second computer is by the proxy server to the first computer.

19. The method of claim 17, wherein the directing of the second computer to transmit a SYN packet to the first computer and the directing of the first computer to transmit a SYN+ACK packet to the second computer is by the proxy server to the second computer.

20. The method of claim 17, wherein the SYN packet transmitted by the first computer to the second computer is blocked at a second firewall device, the second computer being behind the second firewall device and yet the firewall state transitions to SYN_SENT state.

21. The method of claim 17, wherein the SYN packet transmitted by the second computer to the first computer is blocked at a first firewall device, the first computer being behind the first firewall device and yet the firewall state transitions to SYN_SENT state.

22. The method of claim 17, wherein the SYN+ACK packet transmitted by the first computer to the second computer is allowed to pass through a second firewall device, the second computer being behind the second firewall device and the firewall state transitions to ESTABLISHED state.

23. The method of claim 17, wherein the SYN+ACK packet transmitted by the second computer to the first computer is allowed to pass through a first firewall device, the first computer being behind the first firewall device and the firewall state transitions to ESTABLISHED state.

24. An integrated circuit chip for establishing data exchange between systems located in separate private networks, each separate private network having a firewall device, the integrated circuit chip comprising:
logic for establishing a TCP connection between a first computer and a proxy server;
logic for establishing a TCP connection between a second computer and a proxy server;
logic for directing the first computer to transmit a SYN packet to the second computer;
logic for directing the second computer to transmit a SYN packet to the first computer;
logic for directing the first computer to transmit a SYN+ACK packet to the second computer;
logic for directing the second computer to transmit a SYN+ACK packet to the first computer;
logic for directing the first computer to transmit a ACK packet to finish the connection establishment; and
logic for directing the second computer to transmit a ACK packet to finish the connection establishment,
wherein when the second computer receives the SYN+ACK packet transmitted by the first computer, the second computer transitions to a TCP Connection Established state, and when the first computer receives the SYN+ACK packet transmitted by the second computer, the first computer transitions to the TCP Connection Established state.

25. A computer readable media having program instructions for establishing a communication link between two or more computers located in separate private networks, each separate private network having a firewall device, the computer readable media comprising:
program instructions for establishing a TCP connection between a first computer and a proxy server;
program instructions for establishing a TCP connection between a second computer and a proxy server;
program instructions for directing the first computer to transmit a SYN packet to the second computer;
program instructions for directing the second computer to transmit a SYN packet to the first computer;
program instructions for directing the first computer to transmit a SYN+ACK packet to the second computer;
program instructions for directing the second computer to transmit a SYN+ACK packet to the first computer;
program instructions for directing the first computer to transmit a ACK packet to finish the connection establishment; and
program instructions for directing the second computer to transmit a ACK packet to finish the connection establishment,
wherein when the second computer receives the SYN+ACK packet transmitted by the first computer, the second computer transitions to a TCP Connection Established state, and when the first computer receives the SYN+ACK packet transmitted by the second computer, the first computer transitions to the TCP Connection Established state.
